(19) United States
(12) Patent Application Publication
(10) Pub. No.: US 2009/0115597 A1
(43) Pub. Date: May 7, 2009

(54) ENERGY SAVING AND SECURITY SYSTEM

(76) Inventor: Jean-Pierre Giacalone, Santa Clara, CA (US)

Correspondence Address: WOLF GREENFIELD & SACKS, P.C., 600 ATLANTIC AVENUE, BOSTON, MA, 02210-2206, US

(21) Appl. No.: 12/255,205

(22) Filed: Oct. 21, 2008

Related U.S. Application Data
(60) Provisional application No. 61/002,111, filed on Nov. 6, 2007.

(51) Int. Cl. G08B 29/00

(52) U.S. Cl. 340/506

(57) ABSTRACT

A system for administrating a network of heating, cooling, lighting, and motion sensors in a building and using the derived information for detecting status changes in the environmental factors being monitored for subsequent use.

### CROSS-REFERENCE TO RELATED APPLICATION

This application claims the benefit under 35 U.S.C. § 119(e) of U.S. Provisional Application Ser. No. 61/002,111, entitled “Security System,” filed Nov. 6, 2007, which is hereby incorporated by reference in its entirety.

### INTRODUCTION

This invention relates to a system for administrating a network of sensors monitoring lighting, heating, cooling, motion and other environmental factors in a space, detecting status changes in the function being monitored, and using the detected functions for various purposes including controlling environmental factors and reporting human presence.

### BACKGROUND OF THE INVENTION

It has been stated that cities use more than 75% of the world energy and account for 75% of its greenhouse gas effect. Buildings are often the largest energy users, accounting for 50% of energy consumption in newer cities and more than 70% in older ones. In New York City and in London, buildings account for almost 80% of greenhouse gas emissions.

Most buildings, particularly in older cities, are remarkably energy inefficient. City lights generate more heat than light. City buildings leak cool air in summer and hot air in winter because of poorly insulated windows. Their heating and cooling systems are inefficient due to inefficient pumps and motors. Heating, air conditioning and lighting systems often run all night, when no one is using them.

In urban areas, large buildings employ heating, lighting and air conditioning with heterogeneous technologies. In these systems the local use is non-coordinated with other systems. Safety-related information such as who is where is not available. The presence indicator technology currently in use is dedicated to light control that does not account for number of persons The cooling or heating sensors are based on absolute thermal information versus almost vacant areas or dynamic changes due to the uses. Further these systems are not connected due to the lack of standards to do so. Additionally, security is largely not benefiting from presence indicators. Moreover, the overall system's efficiency is lagging behind new energy-saving requirements despite some discrete progress in technology introduction (low consumption bulbs, presence indicators).

### BRIEF SUMMARY OF THE INVENTION

In some embodiments of the invention, a system of networked sensors is configured to control environmental factors within a space. In a space such as a building, the environmental factors may include climate conditions, such as heating, cooling, and lighting, as well as other factors such as security. In some embodiments of the invention, the environmental factors may be monitored and controlled without a central processing element, as each sensor in the network may comprise a portion of a distributed intelligence. In this manner, each sensor in the system may be both a detection element, monitoring local conditions and properties within a sub-space to which it is assigned, and a distributed decision-making element, exchanging data regarding the local conditions and properties with one or more other sensors in the network and controlling controllers of environmental factors (e.g., lights or heating, ventilation, and air conditioning (HVAC) elements). The other sensors with which data may be exchanged by a sensor may be assigned to the same sub-space as the sensor or to other sub-spaces. Based at least in part on its own data and data received from other sensors, a sensor may control local environmental factors within the sub-space to which it has been assigned such that the overall space may be controlled without a central processing element.

### BRIEF DESCRIPTION OF THE DRAWINGS

FIG. 1 is a schematic illustration of an enclosed space such as a building incorporating components of the invention;

FIGS. 2A and 2B illustrate exemplary groups of sensors located in a building;

FIG. 3 schematically illustrates an optical sensor suitable for use in the system;

FIG. 4 is a flow chart illustrating a sensor in accordance with the invention;

FIG. 5A shows an exemplary environment and system of sensors;

FIG. 5B shows an exemplary range of control for lighting in a sub-space;

FIG. 6 is a schematic illustration of a control panel having multiple functional features useful in the invention;

FIG. 7 illustrates the system in an initial stage of operation;

FIG. 8 illustrates the system in an advanced stage of operation;

FIG. 9 illustrates the system in a stage of operation adapting to varying numbers of people;

FIG. 10 illustrates the system in a still further stage of operation to that shown in FIG. 9;

FIG. 11 illustrates the system in further or different stage of operation than shown in FIG. 10, and

FIG. 12 illustrates the system in a typical final stage of operation at the end of a day.

### DETAILED DESCRIPTION OF THE DRAWINGS

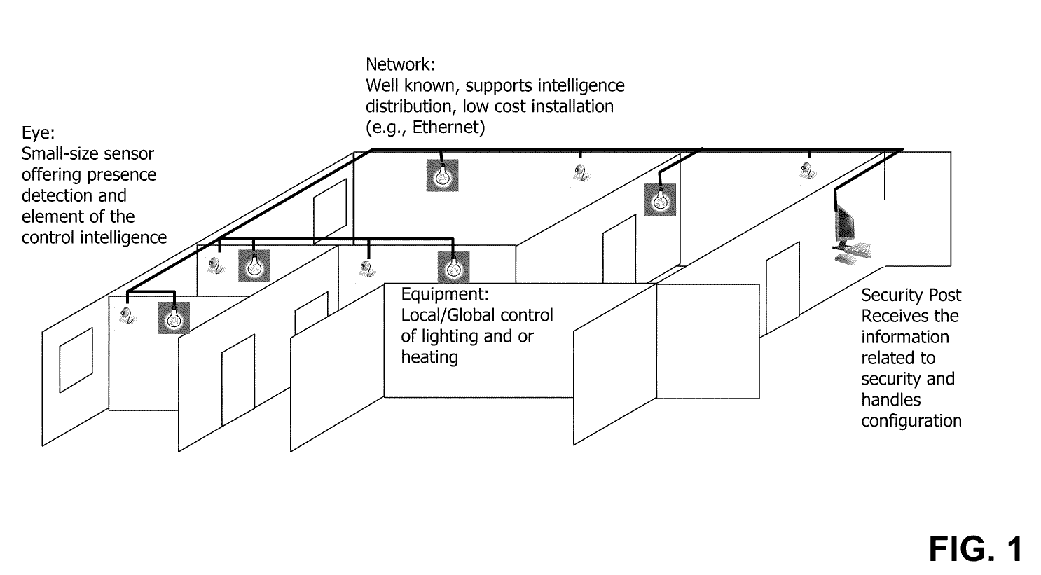

FIG. 1 shows an exemplary space controlled by an illustrative embodiment of the invention operating without a central processing element. The space shown in FIG. 1 is a floor of a building consisting of sub-spaces (e.g., rooms and hallways). Each sub-space has a sensor disposed therein to monitor local conditions and properties of the space, with the sensors being connected to one another and to a security post via a communication network. The communication network may comprise any suitable wired and/or wireless communication medium or media operating according to any suitable communication protocol, including a wireless network such as the Institute for Electrical and Electronics Engineers' (IEEE) 802.11 protocol standard or a wired network such as Ethernet or the IEEE P1901 Broadband over Power Line protocol standard. Using the local condition and property information collected, the sensor may control one or more controllers of environmental factors, including local controllers of local environmental factors. For example, a sensor may be adapted to detect a light level in the sub-space and control lighting in the room accordingly, such that artificial lights in the sub-space may be turned on or brightened as natural light in the room decreases. Alternatively or additionally, a sensor may be adapted to detect the number of people in a sub-space and control the temperature in the sub-space accordingly by, for example, lowering the temperature of the air output by heating/cooling elements to offset the heat generated by the people in the sub-space and thus maintain the sub-space at a particular temperature.

As discussed above, sensors in a system may exchange data regarding the local conditions and properties of the sub-space with other sensors in the network. In some embodiments of the invention, sensors in a network, and the sub-spaces with which the sensors are associated, may be grouped together in groups. The sensors in a group may then exchange data with one another. In some embodiments of the invention, sub-spaces may be grouped accordingly to physical proximity, but it should be appreciated that sub-spaces may be grouped in any suitable manner according to any suitable property.

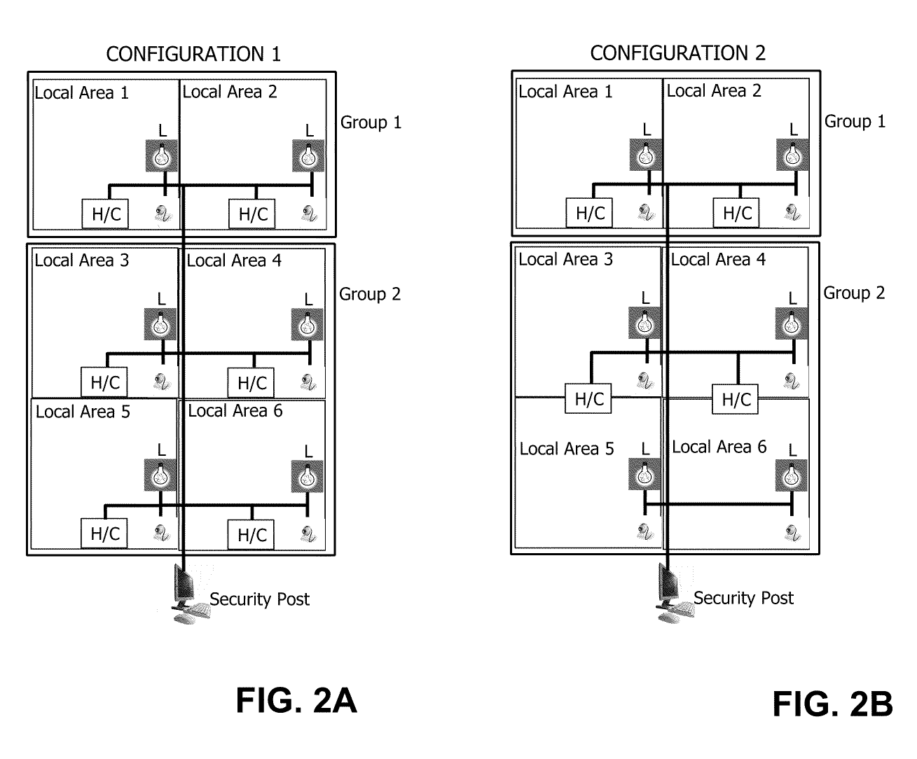

FIGS. 2A and 2B show exemplary groups of sensors in a system. As shown in FIG. 2A, two sub-spaces, Local Area 1 and Local Area 2, are associated with one another in Group 1, and four sub-spaces, Local Areas 3, 4, 5, and 6, are associated with one another in Group 2. Each Local Area may be a sub-space, such as a single room in a building or a portion of a room in a building. The sensors of sub-spaces Local Areas 1 and 2 may be adapted to control the lighting (L) and heating/control (H/C) elements for Local Areas 1 and 2 based on the local conditions and properties of the Local Areas 1 and 2, as well as data received from one another. Exchanging data in this manner enables the sensors in a group to compensate for the conditions and properties of another sub-space when controlling the properties their own sub-space. For example, if a sensor detects that a door between its own sub-space and another sub-space is open, and knows that the temperature is higher in the other sub-space, then the sensor may lower the temperature generated by its own H/C elements to take advantage of the effect the other sub-space has on the sub-space as a result of the temperature differential and the opening between the sub-spaces.

It should be appreciated that the local condition and property information monitored by each of the sensors in each sub-space may be any suitable information, as embodiments of the invention are not limited in this regard. In some embodiments of the invention, the sensor may be adapted to detect how many people are in a room, whether a door or window in the room is open, the type of separator between the sub-space and another space or sub-space, or any other suitable conditions.

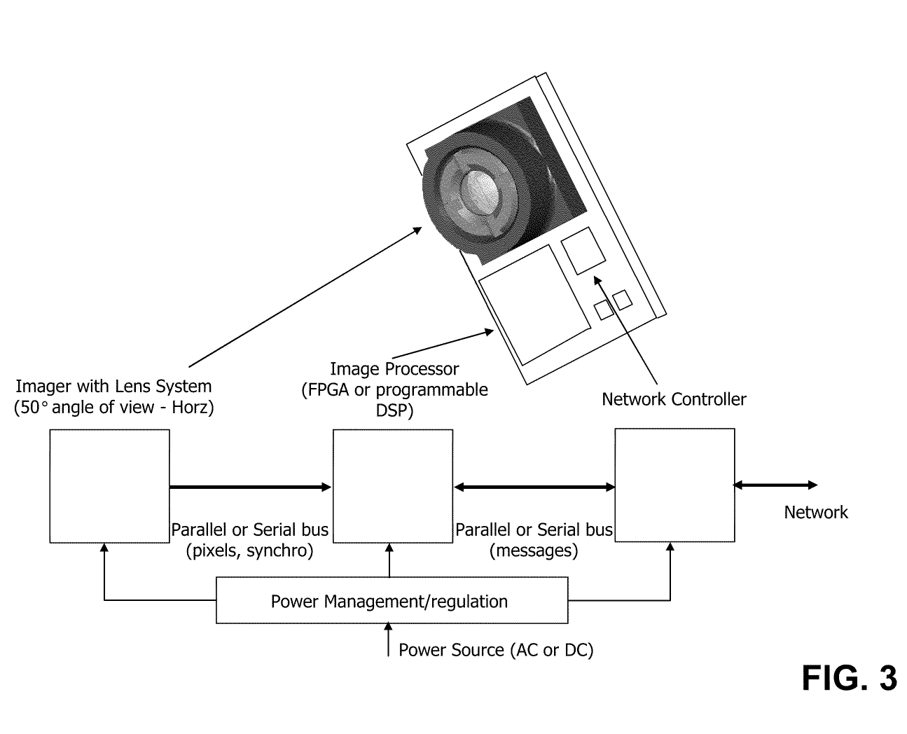

Additionally, it should be appreciated that any suitable type or types of sensors may be implemented to detect the local condition and property information. In some embodiments of the invention, an optical sensor such as the one shown in FIG. 3 may be implemented as a sensor in the system. A sensor may comprise a power supply accepting an Alternating Current (AC) or Direct Current (DC) power input, and may further comprise an optical element such as an image sensor comprising one or more Charge-Coupled Devices (CCDs) or Complementary Metal Oxide Semiconductor (CMOS) sensor. The image sensor may be adapted to monitor visible light, near-infrared light, and/or any other suitable light. The image sensor may be paired with a lens system and may be placed in any suitable placement or orientation in the sub-space, such as at a 50-degree angle to the horizontal. The sensor may further comprise an image processor, and data collected by the image sensor may be passed via any suitable serial or parallel bus to the image processor to be analyzed in any suitable manner.

Any suitable image processing circuit may be implemented as the image processor, including a Field-Programmable Gate Array (FPGA), an Application Specific Integrated Circuit (ASIC), or a programmable digital signal processor (DSP). The image processor may produce messages based on the input from the image sensor. Messages may comprise any suitable information in any suitable format, such as outputs of detection steps (e.g., a temperature of the sub-space or the number of people present in a sub-space), raw image data or other data collected by the sensor, or any other information. These messages may be passed via any suitable serial or parallel bus to any suitable recipient, including other components of the sensor such as a network controller linked to a communication network to which the sensor is connected. The network controller may then transmit the messages to any suitable recipient, such as one or more of other sensors in the network, controllers of environmental factors (heating/cooling elements, lighting, etc.), and security posts, among others.

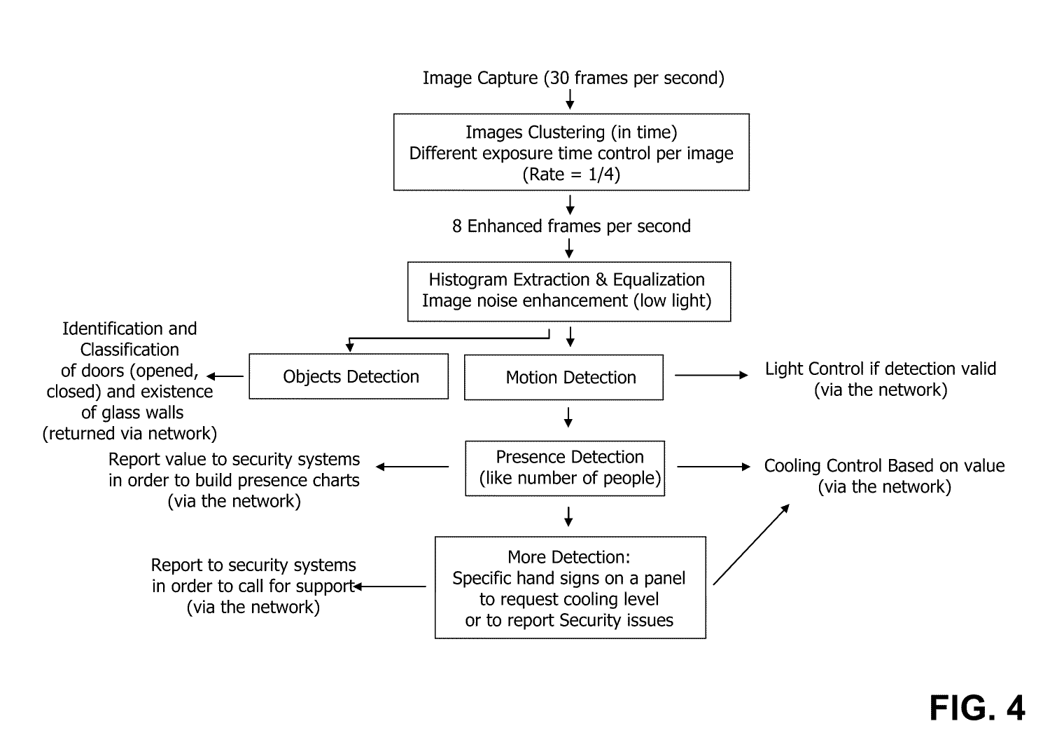

FIG. 4 shows an illustrative process for operating a sensor in accordance with one or more embodiments of the invention. It should be appreciated that the processor shown in FIG. 4 is merely exemplary, and that embodiments of the invention may implement any suitable process for operating a sensor in a network. Additionally, while FIG. 4 is described in conjunction with an optical sensor comprising an image sensor as the sensor used in the network, embodiments of the invention are not limited to operating with optical sensors and may implement any suitable type or types of sensor.

The process of FIG. 4 starts by capturing image data with a sensor at a rate of 30 frames per second. In some embodiments of the invention, the rate of capture may be adjusted between images by adjusting the image processor exposure time for each image. Varying the exposure time allows for a range of images of the same object(s) with different properties, such as contrast. The image data may then be clustered in time to yield eight enhanced frames per second, which may then be processed to be equalized and remove image noise. Clustering may be done in any manner, such as by summing images captured within a certain time period to yield an overall image taking advantage of properties of each of the individual images. For example, an overall image may have a higher overall contrast than the individual images, as it contains each of the high-contrast areas of the individual images rather than the high contrast area of just one image. Following clustering, an overall image may be equalized to yield an enhanced image. The overall image may be processed to balance overall lighting in the image such that under-exposed areas of the image may be better analyzed, and noise-filtering using any suitable filtering algorithm, such as bilinear filtering, may be applied to the image.

The enhanced images may then be analyzed alone and in combination with other images to perform several steps, including object detection and motion detection. Object detection may comprise analyzing one or more images in any suitable manner to determine the presence, type, and/or state of one or more objects depicted in the image (and therefore in the sub-space). For example, the one or more images may be analyzed to determine whether the sub-space contains doors or windows, and whether any detected doors or windows are open or closed. Additionally or alternatively, the one or more images may be analyzed to determine the location and type of any walls in the room, such as whether a wall dividing two sub-spaces is a glass wall. This detection may be done in any suitable manner, such as by detecting doors using any suitable edge detection algorithm and/or comparing the image or areas of the image to stored models and patterns of detected doors. A glass wall may also be detected in any suitable manner, such as by detecting light passing through a wall or an area of a wall. If light is passing through the wall and there is no door in the wall, or the door is closed, then the system may determine that the wall is at least partially a glass wall. As a further alternative, sensors implemented by embodiments of the invention may comprise a memory in which an administrator of the system may store information about the space or sub-space to which the sensor has been assigned, such as the location and properties of walls and doors, which a sensor may use in performing object detection. It should be appreciated that these examples are merely illustrative, and that any suitable determination may be made from object detection steps as embodiments of the invention are not limited in this regard.

Motion detection algorithms may also be applied to one or more images generated by a sensor. The motion detection algorithms may be applied to determine, for example, whether there are people present in the sub-space and/or the number of people present in a sub-space. The output of this determination may be used in any suitable manner, such as by turning on the lights if there are people present in the room, informing a security post of the number of people present in a room, and/or controlling heating/cooling elements based on the number of people in a room.

Results of motion detection and object detection may be used in any suitable manner for determining lighting or temperature levels for a sub-space. For example, results of object and motion detection from the sensor and from other sensors within a group may be used to calculate various factors for the sub-space. For example, the factors may include current/previous control levels (CL) for the sub-space (including other sub-spaces in a group), indicating the current (at the time of analysis) lighting/heating/cooling levels of the sub-space. A Number of Persons Present (NPP) factor may also be calculated. Lastly, the Neighboring Area Access Contribution (NAAC) may be calculated from various conditions and properties—including, for example, whether or not there are glass walls in the sub-space, whether or not doors/windows are open in the sub-space, and the number of people present in the sub-space—to determine the effect a neighboring sub-space has on the sub-space. To calculate a value for NAAC, in some embodiments of the invention the number of conditions or properties of a sub-space that increase the effect another sub-space has on the sub-space may be determined. For example, a sub-space with a glass wall and an open door to other sub-spaces may be determined to have a NAAC of 2 (one glass wall and one open door, 1+1=2) while a sub-space with a glass wall and a closed door may be determined to have a NAAC of 1 (one glass wall and no open doors, 1+0=1). These factors (CL, NPP, and NAAC) may then be weighted against one another in determining a “center of gravity” for a group of sub-spaces such that the environmental factors of the individual sub-spaces in the group may be controlled according to how the sub-spaces are being affected by the other sub-spaces. The factors calculated may be weighted when determining an eventual overall Control Level for each sub-space, according to an equation such as:

ΣW_{CL}·CL+W_{NPP}·NPP+W_{NAAC}·NAAC

where W_{CL}+W_{NPP}+W_{NAAC}=1, and W_{CL}, W_{NPP}, and W_{NAAC} are coefficients chosen to tune distributed behavior.

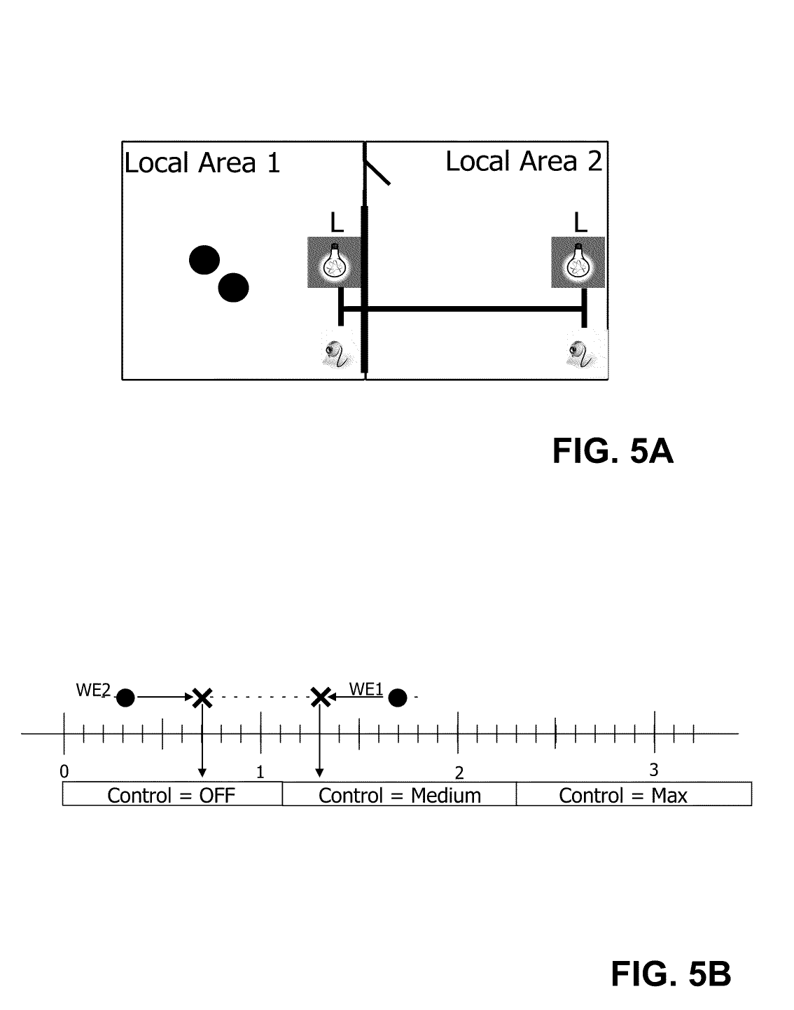

FIG. 5A shows an exemplary environment in which a system of sensors may be controlled according to this equation or any other suitable control equation. In the environment of FIG. 5A, a space comprises two sub-spaces, Local Area 1 and Local Area 2. Each sub-space has within it a sensor which detects properties and conditions of the room in any manner, including the exemplary techniques described above, and uses the detected properties and conditions to control lighting in the sub-space. In the example, lighting may be set at any of three levels: off, medium, or maximum. Each of Local Areas 1 and 2 are configured to weight the number of persons present (W_{NPP}) at 0.4, the previous control levels (W_{CL}) at 0.3, and the neighboring area access contribution (W_{NAAC}) at 0.3. Sensors in the exemplary environment are configured to use integer values for previous control levels, with off as 0, medium as 1, and maximum as 2.

As shown in FIG. 5A, two people are in Local Area 1, and there is a door and a glass wall between Local Areas 1 and 2. Additionally, the lights in Local Area 1 are currently set to generate maximum illumination, while the lights in Local Area 2 are off. To calculate control levels for the next iteration of the system, sensor 1 sums the weighted values of each of the determined factors for the room. With CL=2 (lighting levels at maximum), NPP=2 (two persons in the room), and NAAC=1 (one glass wall), the Weighted Evaluation for the Local Area 1 is 0.3*2+0.4*2+0.3*1=1.7. Similarly, for Local Area 2, where CL=0, NPP=0, and NAAC=1, the Weighted Evaluation is 0.3*0+0.4*0+0+3*1=0.3. Lastly, the sensors exchange their calculated Weighted Evaluations such that each may calculate a Weighted Center of Gravity which will balance control between the sub-spaces to ensure efficiency in control. To calculate the Weighted Center of Gravity, each Weighted Evaluation is again weighted in a sum according to weights provided to or determined by the sensors. In some embodiments of the invention, the weights will be determined by the sensors from conditions or properties of a sub-space, or from other the weights of the conditions and properties described above (e.g., W_{NPP}), or in any other suitable manner. In determined the Weighted Center of Gravity, each sensor may give its own Weighted Evaluation more weight than the Weighted Evaluation of the other sensor, or may weighted the Weighted Evaluations in any other suitable manner.

In the example of FIG. 5A, the sensor for Local Area 1 will calculate the Weighted Center of Gravity as 0.7*WE1+0.3*WE2=0.7*1.7+0.3*0.3=1.3. Local Area 2 will likewise calculate 0.7*WE2+0.3*WE1=0.7*0.3+0.3*1.7=0.7. These values will then be compared to a control range for lighting, such as the exemplary control range shown in FIG. 5B. As shown in FIG. 5B, if a sensor determines a control value between 0 and 1.1, the lights will be turned off, whereas for a value between 1.2 and 2.3 or 2.3+ the lights will be set at medium or maximum, respectively. Accordingly, the sensor for Local Area 1 will reduce the lighting to medium, and the sensor for Local Area 2 will keep the lights off.

It should be appreciated that the environment and configuration shown in FIGS. 5A and 5B are merely exemplary and the embodiments of the invention may operate in any suitable environment and determine control levels according to any suitable algorithm using any suitable equation or equations.

Additionally or alternatively, motion detection algorithms may be used as gesture detection algorithms to determine whether a person in the room is signaling the system to perform one or more tasks such as change the temperature or summon security. As shown in FIG. 5, an area of a sub-space, such as a portion of a wall in the sub-space, may be designated by the system as a control panel by which a person in the sub-space may interact with the sensor for the sub-space. FIG. 5 depicts such a wall divided into four quadrants. The top-left quadrant may be used to summon security or other emergency services by placing a flat hand in the quadrant for two seconds. If a flat hand is placed in the top-right quadrant for more than one second, then the system may detect that the person is requesting more air conditioning (i.e., the system should cool the room). A flat hand placed in the bottom-left quadrant for at least one second may signal a request for less air conditioning, while the bottom-right quadrant allows a user to signal that the lights and climate control in the sub-space should be turned off in ten seconds.

It should be appreciated that gesture detection may be performed in any suitable manner and is not limited to detecting particular gestures made by a person in relation to a wall, as embodiments of the invention are not limited to implementing any particular gesture detection process. Additionally, it should be appreciated that embodiments of the invention which implement gesture detection in relation to a wall may divide the wall into any number of quadrants, including zero quadrants, and may detect any suitable gesture or gestures and perform any suitable task in response to the gesture(s).

It should be further appreciated that embodiments of the invention are not limited to implementing the exemplary process for operating a sensor shown in FIG. 4, as embodiments of the invention may implement any suitable process for operating a sensor. Alternative embodiments of the invention may implement similar processes comprising similar acts, or may implement processes not comprising any of the steps shown in FIG. 4. As an example of an alternative embodiment, while FIG. 4 describes a process for operating a sensor to analyze images generated by the sensor, in embodiments of the invention the sensor may additionally or alternatively process image data received as messages from other sensors. As a further example, in some embodiments of the invention each sensor may not execute all steps shown in the process of FIG. 4 but rather a single sensor may be assigned control responsibility for a group of sensors and may be the only sensor issuing control instructions while other sensors detect local conditions and properties and transmit data to the one sensor.

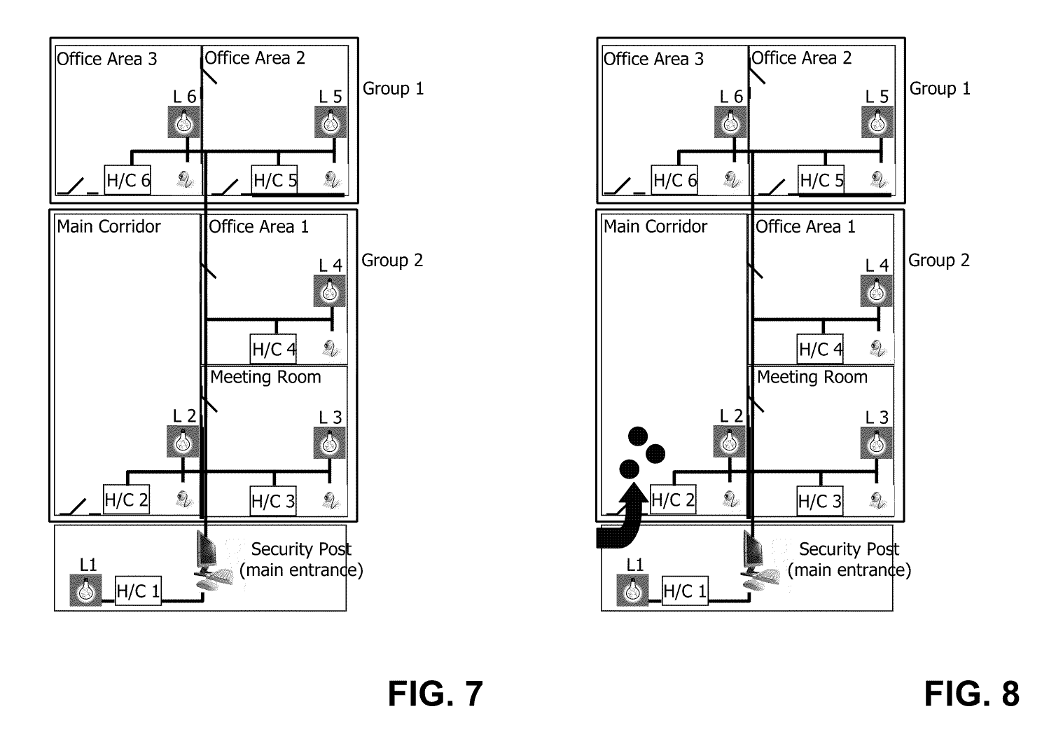

FIGS. 7-12 depict techniques for operating one embodiment of the system implemented in a space comprising subspaces such as hallways, meeting rooms, offices, and security posts, with conditions and properties of the space changing throughout the day according to use of the sub-spaces. It should be appreciated that the embodiment shown in operation in FIGS. 7-12 is merely exemplary, and that other implementations are possible. Further, it should be appreciated that any suitable process for controlling a system may be implemented by embodiments of the invention, and that embodiments of the invention are not limited to operating according to the illustrative techniques shown and described in conjunction with FIGS. 7-12.

FIG. 7 shows an exemplary space divided into sub-spaces such as Office Areas 1, 2, and 3, a Main Corridor, a Meeting Room, and a Security Post. Office Areas 2 and 3 are shown associated with one another as Group 1, while the Main Corridor, Office Area 1, and the Meeting Room are shown associated with one another as Group 2. In Group 1, for Office Area 3 the control factors are primarily weighted toward number of persons present (NPP) while in Office Area 2 the control factors are weighted equally toward NPP and the Neighboring Area Access Contribution (NAAC). Thus, below, Office Area 3 will be controlled primarily by the number of persons present in Office Area 3, while Office Area 2 will be controlled equally be the number of persons present and by the contributions of neighboring areas (i.e., Office Area 3 and Office Area 1). In Group 2, the Main Corridor has been configured to make control decisions primarily based on the number of persons present in the Main Corridor, while Office Area 1 and the Meeting Room have been configured to depend equally on NAAC and the control levels already set in those sub-spaces. Thus, below control of the Main Corridor will depend mainly on the number of people in the corridor, while Office Area 1 and the Meeting Room will be controlled based on the state of nearby sub-spaces (e.g., the Main Corridor) and by the previous state of their controllers of environmental factors. It should be appreciated that these configurations are merely exemplary, and that embodiments of the invention may configure sub-spaces to be controlled in any manner based on any suitable weighting of factors.

As shown in FIG. 7, each sub-space has heating/cooling equipment (H/C) and lighting equipment (L) assigned to it, as well as a sensor. The Meeting Room and the Main Corridor are shown having a glass wall between them, as are Office Areas 1 and 2. There are doors shown between some of the sub-spaces, such as a door between the Main Corridor and Office Area 3.

FIG. 7 shows the space in an initial configuration at the start of an illustrative work day, when no one is using the sub-spaces. L1 and H/C1 of the Security Post sub-space are on permanently, with all other lighting equipment (L2-L6) off and all other heating/cooling equipment (H/C2-H/C6) off or at minimum operation. At the time shown in FIG. 7, the average temperature through the entire space (through all sub-spaces) is 22 degrees Celsius, and the system has been configured to maintain a temperature of 20-21 degrees Celsius when the space is being used (i.e., an occupied sub-space should have a temperature of 20-21 degrees Celsius).

FIG. 8 shows how the system may adapt when one or more sensors detects that one or more sub-spaces is being used. Three people, who may have just arrived for work in the morning, move into the Main Corridor sub-space from the Security Post sub-space. The sensor for the Main Corridor detects the three persons, as well as other local conditions and properties of the Main Corridor including that the door to Office Area 1 is open and the doors to Office Area 3 and the Meeting Room are closed. The sensor for the Main Corridor then processes this data and exchanges messages with each of the other sensors in its group (i.e., the sensors for the Office Area 1 and Meeting Room). Each of the sensors then arrives at a common conclusion—using any suitable technique, including the exemplary techniques discussed above—that the lighting equipment L2 should be brought up to maximum level, and the heating/cooling equipment H/C2 should be configured to generate air in the Main Corridor at a temperature of 21 degrees Celsius. This may be done because the Main Corridor is configured to react primarily to the number of persons present in the corridor and not to other factors, while Office Area 1 and the Meeting Room are configured to react primarily to NAAC and the previous state of their controllers (off). Thus, the Main Corridor will be controlled according to NPP and will cool the corridor and bring up the lights, while the sensors Office Area 1 and Meeting Room will decide to remain off and depend on the cooling and lighting effects of the controllers of the Main Corridor to affect conditions in these sub-spaces.

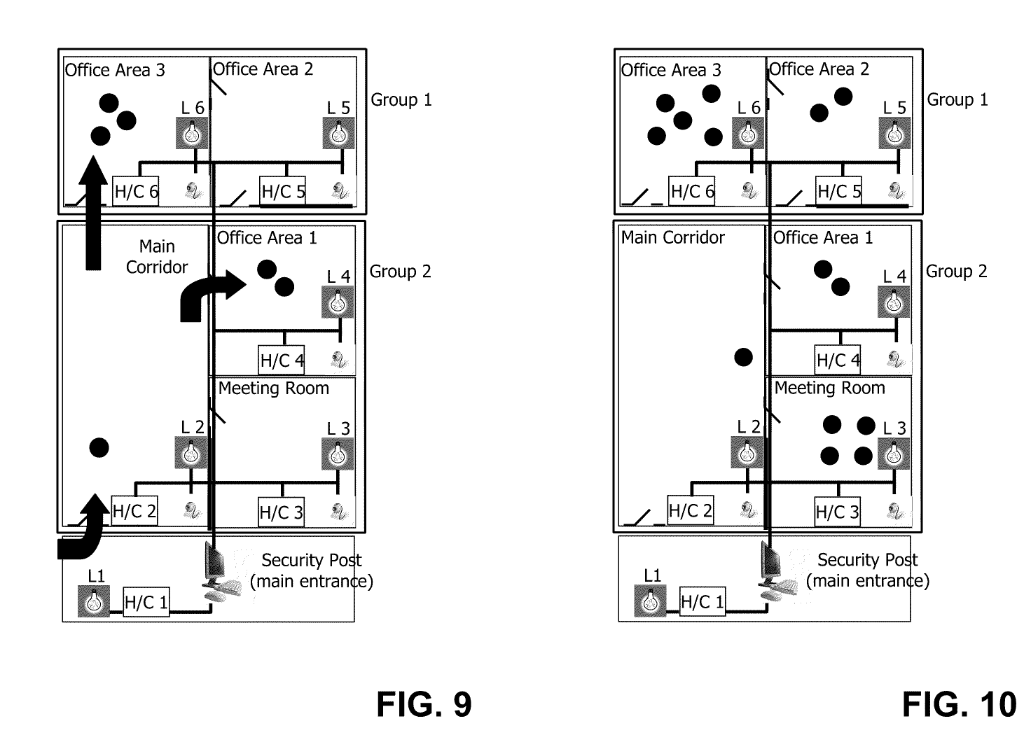

FIG. 9 shows how the system adapts as more people move into the space, and as people move into different sub-spaces. As shown in FIG. 8, there is one person in the Main Corridor, two people in the Office Area 1, and three people in the Office Area 3. The sensors of Group 2 detect (i.e., the individual sensors in the sub-spaces detect, and pass relevant messages to the other sensors of Group 2) the use of the sub-spaces Main Corridor and Office Area 1, exchange messages regarding the local conditions and properties of the sub-spaces, and configure L2 and L4 to generate light at the maximum level and H/C2 to decrease the temperature of its generated air to 20 degrees Celsius. H/C4 is either not turned on or is left at minimum operation (depending on the initial configuration of FIG. 7). Because the door between the Office Area 1 and Main Corridor is open, and the sensor of Office Area 1 has been configured to base its decisions primarily on the previous state of its controllers and the effects of neighboring areas on Office Area 1) the sensor will accordingly depend on the cold air generated by the H/C2 to cool the Office Area 1 instead of turning on or adjusting H/C4.

The sensors of Group 1 in FIG. 9 also detect use of the sub-space Office Area 3 and non-use of the Office Area 2, exchange messages regarding the local conditions and properties of the sub-spaces (e.g., three people in Office Area 3, doors to the Main Corridor and Office Area 2 open, door to Office Area 1 closed), and arrive at a common conclusion for controlling the environmental factors of the sub-spaces associated with Group 1. Based on the occupancy of Office Area 3 and the configuration of the sensor (i.e., it will base its decisions primarily on NPP, and not NAAC or CL), L6 is configured to generate maximum illumination, and H/C6 is configured to generate air at 21 degrees Celsius to cool the sub-space.

FIG. 10 shows the space of FIGS. 7-9 later in the day, as occupancy of the space increases and as occupancy of the sub-spaces changes. As shown in FIG. 10, five people occupy Office Area 3, two people occupy Office Areas 1 and 2, one person occupies the Main Corridor, and four people occupy the Meeting Room. The sensors of each of the sub-spaces detect this occupancy, as well as other local conditions and properties of the sub-spaces. For example, the sensor of the Meeting Room may determine that the light generated by the lighting equipment L2 of the Main Corridor is visible through the glass wall between the Main Corridor and the Meeting Room. The sensors of Group 2 may also determine that the doors of the Office Areas 1, 2, and 3 are open. Additionally, the sensors of Group 1 may determine that the doors to the Main Corridor and Office Areas 1 and 2 are open, and that the light generated by L4 of Office Area 1 is visible in Office Area 2 through the glass wall between the sub-spaces. Based on the determinations of the sensors in Group 2, L2 and LA may be configured to generate maximum light, L3 to generate medium light (based on the light passing through the glass wall from the Main Corridor), H/C2 may be configured to maintain a generated air temperature of 20 degrees Celsius, H/C4 may be left at minimum operation (or off), and H/C3 may be configured to decrease the temperature of the Meeting Room by generating air at 21 degrees Celsius. These determinations are based not only on the detected conditions, but also on the configuration of the sensors. The sensors of Office Area 1 and the Meeting Room are configured to respond equally to NAAC and CL, while the sensor of the Main Corridor is configured to respond primarily to NPP. Here it can be seen that despite the Meeting Room's configuration to depend primarily on NAAC and CL, the sensor has adjusted H/C3 because the conditions in the room (the door to the Main Corridor is closed) mean that the actual NAAC is low and the NPP for the room (four) is high. Thus, sensors in the system can be configured to respond adequately to conditions despite energy-saving configurations.

Based on the determinations of the sensors of Group 1, L6 may be configured to generate light at the maximum level, while L5 may be configured to generate light at a medium level based on the light detected as passing through the glass wall of Office Area 2. Additionally, H/C6 may be configured to decrease its generated air temperature to 19 degrees Celsius to offset the number of people in the small area Office Area 3, and H/C5 may be configured to generate air at 21 degrees Celsius (based in part on the open door between Office Area 1 and 2). As above, these determinations are based not only on the detected conditions, but also on the configuration of the sensors. The sensor of Office Area 3 is configured to respond primarily to NPP, while the sensor of Office Area 2 is configured to respond equally to NPP and NAAC.

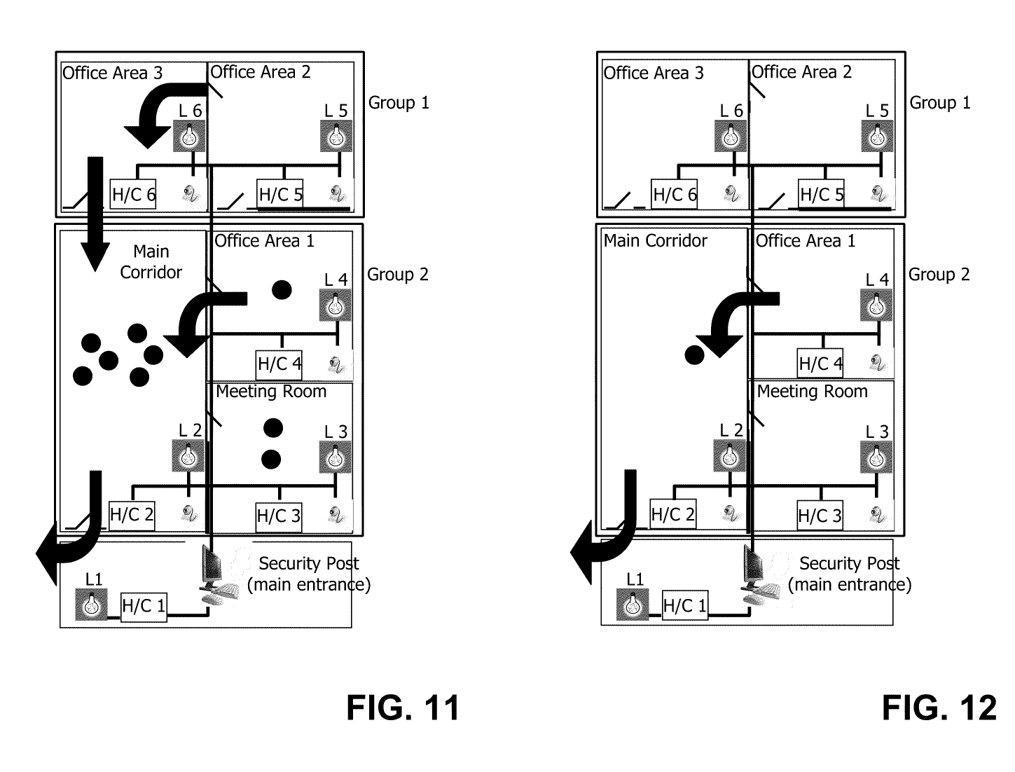

FIG. 11 shows how the system may react as occupancy of the space decreases at the end of the day. As shown in FIG. 10, the sensors of Group 2 detect six people in the Main Corridor, one person in the Office Area 1, and two people in the Meeting Room. The sensors of Group 2 also detect that the doors to Office Areas 1, 2, and 3 are open, and the door to the Meeting Room is closed. Lastly, the sensors of Group 2 determine that the light generated by L2 in the Main Corridor is visible in the Meeting Room through the glass wall. The sensors of Group 2 may then use this information—both the information detected locally and received from other sensors in the group—to determine that L2 and L4 should be configured to generate maximum-level light and L3 should generate medium-level light. The sensors may be adapted to determine that the people in the Main Corridor are moving toward the exit, and may accordingly control H/C2 to generate air at 21 degrees Celsius because it is no longer necessary to accommodate for the people leaving the space. H/C4 may be left at minimum operation (or off) based on the open door, and H/C3 may remain configured to generate air at 21 degrees Celsius.

Group 1 sensors of FIG. 11 will detect that the Office Areas 2 and 3 are unoccupied and that the Main Corridor and Office Areas 1 and 2 doors are open. After exchanging messages indicating these local conditions and properties, the sensors may accordingly arrive at a common conclusion that the light equipment L5 and L6 should be switched off, and H/C5 and H/C6 should be configured to operate at a minimum level or switched off.

FIG. 12 shows how the system adapts to further occupancy decrease at the end of the day. The sensors of Group 1 will detect that the Office Areas 2 and 3 are still unoccupied and will leave the lighting and heating/cooling equipment of those sub-spaces at their previous configurations. The sensors of Group 2 will detect that one person is in the Main Corridor, and the other sub-spaces are unoccupied. Accordingly, the sensors of Group 2 will turn off the lighting equipment L3 and LA, will configure H/C 3 and 4 to operate at minimum levels (or turn them off), and will configure H/C2 to generate air at a temperature of 21 degrees.

Once the last person has left the space, then the sensors of both Groups 1 and 2 will detect that there is no occupancy of any of the sub-spaces, and will accordingly leave lighting and heating/cooling equipment at its previous values or, such as in the case of L2 and H/C2, will turn the equipment off or set it to operate at minimum levels. In this manner, the space may be returned to its original configuration (the beginning of day configuration) shown in FIG. 7.

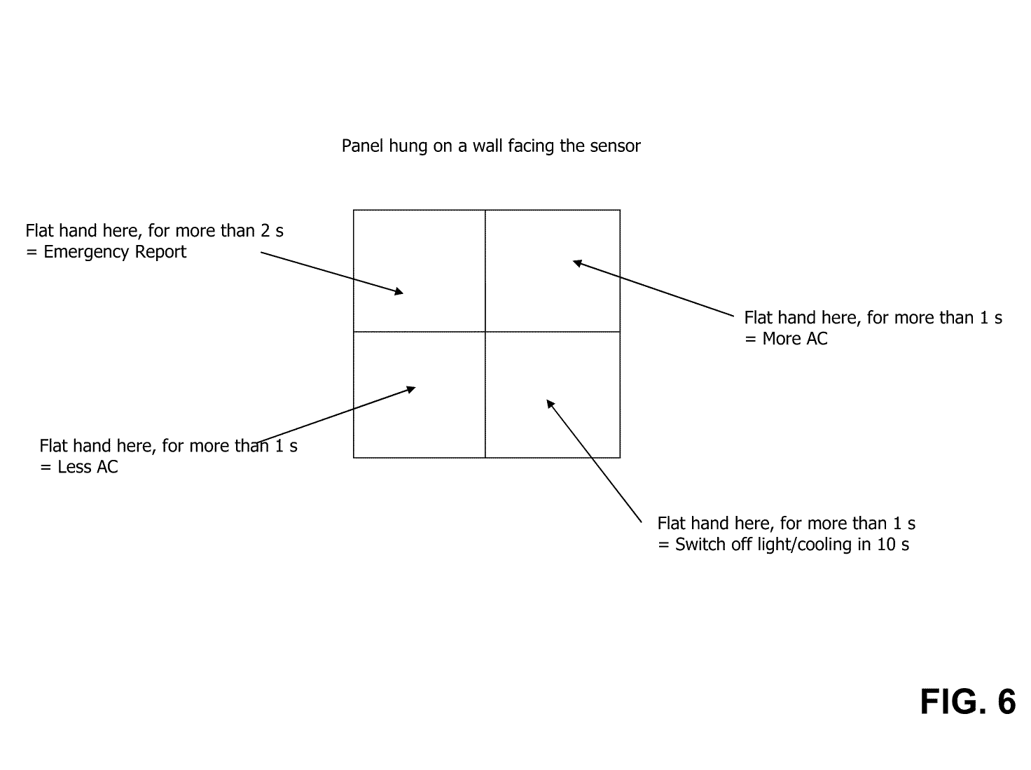

As discussed above, it should be appreciated that the embodiment of the invention shown in FIGS. 7-12 is merely exemplary, and that embodiments of the invention are not limited to being implemented in the space shown in FIGS. 6-11 and are not limited to operating according to the techniques shown in and described in conjunction with FIGS. 7-12. Embodiments of the invention may be implemented in any suitable space and may be configured to operate in that space in any suitable manner according to any suitable technique or techniques.

What is claimed as new and desired to be protected by Letters Patent of the United States is:

1. A system for monitoring and controlling environmental factors in a space, the system comprising:
at least one sensor adapted to monitor heating, cooling, and motion environmental factors in the space; and
at least one controller adapted to control the environmental factors in the space based at least in part on first input data from the at least one sensor in the space and second input data from a source outside the space,
wherein the at least one controller is adapted to control the environmental factors by determining changes in the first and second input data to determine status changes in the environmental factors being monitored, and providing signal outputs instructing adjustments in the environmental factors based on the status changes.
